(19) United States
(12) Patent Application Publication
(10) Pub. No.: US 2006/0020999 A1
(43) Pub. Date: Jan. 26, 2006

(54) Connecting infrared (IR) controllable devices to digital networks

(76) Inventor: John M. Schlarb, Duluth, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/883,341

(22) Filed: Jul. 1, 2004

(51) Int. Cl. H04N 7/16

(52) U.S. Cl. 725/153

(57) ABSTRACT

Systems and methods are presented for connecting IR-controllable devices to digital networks. One embodiment, among others, includes an apparatus comprising digital-signal-receive logic and convert logic. The digital-signal-receive logic is configured to receive a digital signal. The convert logic is configured to convert the digital signal into an infrared (IR) command signal for an IR-controllable device. Another embodiment, among others, includes a method comprising the step of converting a digital signal into an IR command signal for an IR-controllable device. The method further comprises the step of transmitting the IR command signal to the IR-controllable device.

### FIELD OF THE DISCLOSURE

The present disclosure relates generally to digital networks and, more particularly, to providing compatibility between digital networks and infrared (IR) controllable devices.

### BACKGROUND

Much of multi-media entertainment is migrating to digital format. Given this migration, audio-visual devices, such as televisions, are being manufactured with digital capabilities. These digital televisions (DTVs) are configured for compatibility with digital networks, such as, for example, IEEE-1394 (or FireWire) compliant networks. In addition to DTVs, other digital equipment with IEEE-1394 compatibility is also being manufactured.

Despite the expansion into the digital realm, there are still analog devices that are not configured for connectivity to digital networks. Thus, a heretofore unaddressed need exists in the industry.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing an embodiment, among others, of a digital network having network-compliant devices.

FIG. 2 is a block diagram showing an embodiment, among others, of infrared (IR) controllable devices connected to a network-compliant device on the digital network of FIG. 1.

FIG. 3 is a block diagram showing examples of IR-controllable devices that are within range and beyond range of an IR remote control device.

FIG. 4 is a block diagram showing IR-controllable devices that are connected to the digital network through a converter, in accordance with one embodiment, among others, of a system for connecting IR-controllable devices to a digital network.

FIG. 5 is a block diagram showing IR-controllable devices that are connected to the digital network through a converter, in accordance with another embodiment, among others, of a system for connecting IR-controllable devices to a digital network.

FIG. 6 is a block diagram showing an embodiment, among others, of the components of the converter.

FIG. 7 is a block diagram showing another embodiment, among others, of the components of the converter.

FIG. 8 is a block diagram showing an embodiment, among others, of logical components configured to convert digital signals into IR-command signals.

FIG. 9 is a flowchart showing an embodiment, among others, of a process for connecting IR-controllable devices to a digital network.

### DETAILED DESCRIPTION OF THE EMBODIMENTS

Reference is now made in detail to the description of the embodiments as illustrated in the drawings. While several embodiments are described in connection with these drawings, there is no intent to limit the invention to the embodiment or embodiments disclosed herein. On the contrary, the intent is to cover all alternatives, modifications, and equivalents.

Digital networks are gaining popularity in audio-visual environments due to their versatility. For example, digital televisions (DTVs) and other digital equipment are now being manufactured with digital input/output (IO) ports. These IO ports include, but are not limited to, Institute of Electrical and Electronics Engineers (IEEE) 1394-compliant ports, universal serial bus (USB) ports, ethernet ports, and variants thereof. These digital ports permit direct connection of the digital equipment to a compatible digital network. The IEEE-1394 bus, which is an example of a backbone for a digital network, permits connection of multiple digital devices over a single physical bus with separation of the devices within a logical space.

Many multimedia devices do not have IO ports for connecting with digital networks. In that regard, these devices are typically not directly connectable to digital networks. The various embodiments disclosed herein, among others, provide systems and methods for connecting devices without digital connectors (e.g., legacy devices that are unable to received digital network control signals) to digital networks.

One embodiment, among others, of a system for providing such connectivity includes a digital input port, a converter, and an IR transmitter. The digital input port is configured to receive a digital signal from a bus, such as, for example an IEEE-1394 or similar bus. The converter is configured to convert the digital signal into an infrared (IR) command signal. The IR command signal commands an IR-controllable device. The IR transmitter is configured to transmit the IR command signal to the IR-controllable device. By converting digital signals, such as IEEE-1394-compliant signals, into IR-command signals, this embodiment of the system permits control of IR-controllable devices from other devices, such as IEEE-1394-compliant devices, on a digital network.

Another embodiment, among others, is a method for providing connectivity between IR-controllable devices and digital networks. As such, one embodiment, among others, of the method comprises the steps of receiving a digital signal, converting the digital signal into an infrared IR-command signal for an IR-controllable device, and transmitting the IR command signal to the IR-controllable device. For some embodiments, among others, the digital signal is received over a bus, such as an IEEE-1394-compliant bus, a USB, an ethernet bus, or other digital bus. Again, by providing a method of converting digital signals, which originate from a digital network, into IR-command signals, IR-controllable devices can be controlled by any digital device that is on the network.

In yet another embodiment, an apparatus for connecting IR-controllable devices with digital networks is provided. One embodiment, among others, of such a device includes digital-signal-receive logic, and convert logic. The digital-signal-receive logic is configured to receive a digital signal, preferably over a digital network, such as, for example, an IEEE-1394-compliant network, a USB-compatible network, an ethernet, or other digital network. The convert logic is configured to convert the digital signal into an infrared (IR) command signal for an IR-controllable device. Such an apparatus provides an interface between the IR-controllable device and the digital network, thereby providing analog devices a connection to the digital network.

Various embodiments of systems and methods are provided in greater detail below. It should, however, be appreciated that the following description and the accompanying drawings are merely intended to illustrate various embodiments of the invention, and to enable one having ordinary skill in the art to make and practice the disclosed embodiments. As such, the drawings and corresponding descriptions are not intended to be limiting.

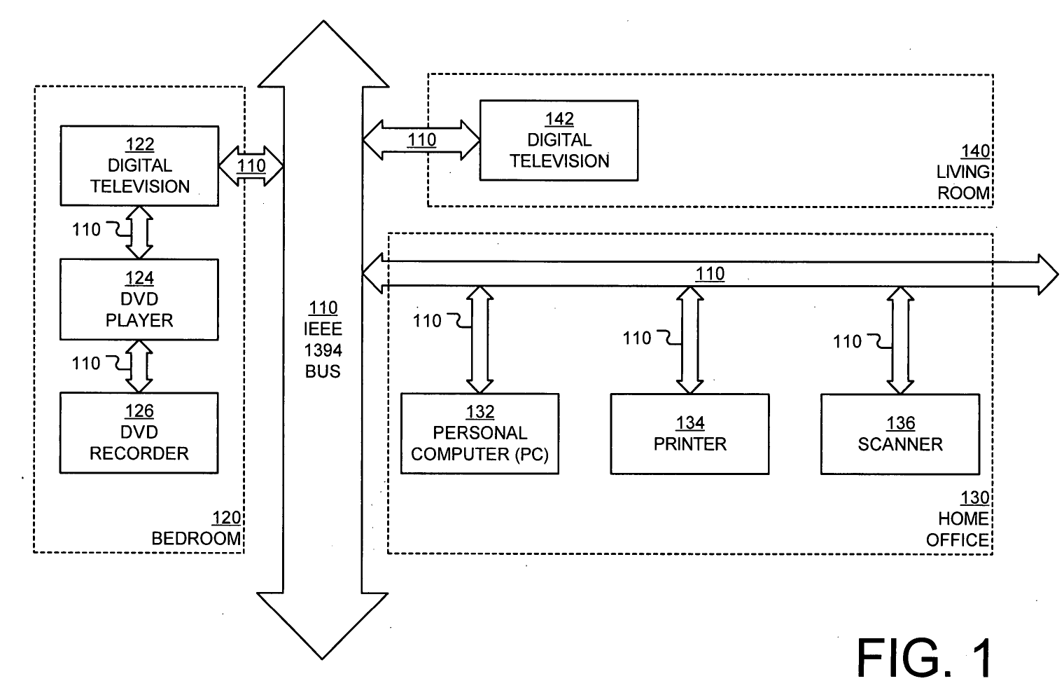

FIG. 1 is a block diagram showing a digital network having network-compliant devices. As is known in the art, one or more of these digital devices can be controlled using known infrared (IR) remote controllers. Specifically, FIG. 1 shows a digital network that is compliant with IEEE-1394 standards. While the digital network has an IEEE-1394-compliant backbone, it should be appreciated that the digital network can also have a USB backbone, a 10 BaseT unshielded twisted pair (UTP) backbone, a small computer system interface (SCSI) backbone, a 100 BaseT backbone, or any variant thereof. For example, a variant of the IEEE-1394 standard can include the IEEE-1394A standard, the IEEE-1394B standard, or future developments stemming from these variants of the IEEE-1394 standard. Also, variants of USB can include high-rate USB, USB 2.0, or future developments that stem from these enumerated USB variants. Likewise, variants of SCSI can include fast SCSI, ultra SCSI, wide ultra SCSI, ultra 2 SCSI, wide ultra 2 SCSI, ultra 3 SCSI, or future developments that stem from these enumerated SCSI variants.

As shown in FIG. 1, the digital network includes a digital bus, such as, for example, the IEEE-1394 bus 110. The IEEE-1394 bus 110 is configured in a branched topology that extends in various rooms of a home, such as, for example, a bedroom 120, a home office 130, and a living room 140. Within these rooms 120, 130, 140, various digital devices are connected to the IEEE-1394 bus 110. For example, in the bedroom 120, a digital television (DTV) 122 is connected to the IEEE-1394 bus 110. A digital versatile disc (DVD) player 124 and a digital camcorder 126, which are also IEEE-1394 compliant, are digitally daisy-chained to the IEEE-1394 backbone through the DTV 122.

In the embodiment of FIG. 1, a sole DTV 142 is located in the living room 140. That DTV 142 is also connected to the IEEE-1394 backbone, thereby permitting the DTV 142 to communicate with the DTV 122 in the bedroom 120. Since the DVD player 124 and the digital camcorder 126 in the bedroom 120 are also IEEE-1394 compliant, the DTV 142 in the living room 140 also has access to those devices due to their daisy-chain connection to the DTV 122 of the bedroom 120.

The home office 130, in the embodiment of FIG. 1, has a personal computer (PC) 132, a networked printer 134, and a networked scanner 136, which are each directly connected to the IEEE-1394 backbone. It should be appreciated that these devices 134, 136, 132 can also be daisy-chained to the IEEE-1394 backbone, similar to the daisy-chain configuration shown for the bedroom 120. Since all of these devices are IEEE-1394 compliant, each of these devices on the digital network can be accessed by all of the other devices on the IEEE-1394 network. While home office devices are not currently compatible with multimedia devices, because they use different variants of the 1394 specification, those devices can be properly configured to be compatible with other 1394 devices, such as, for example, printing an image from a digital television (DTV) to a network printer. Since the IEEE-1394 standard and its variants are known to those having skill in the art, further discussions of the IEEE- 1394 standard and its variants are omitted here, and those standards are incorporated herein by reference, as if set forth in their entireties.

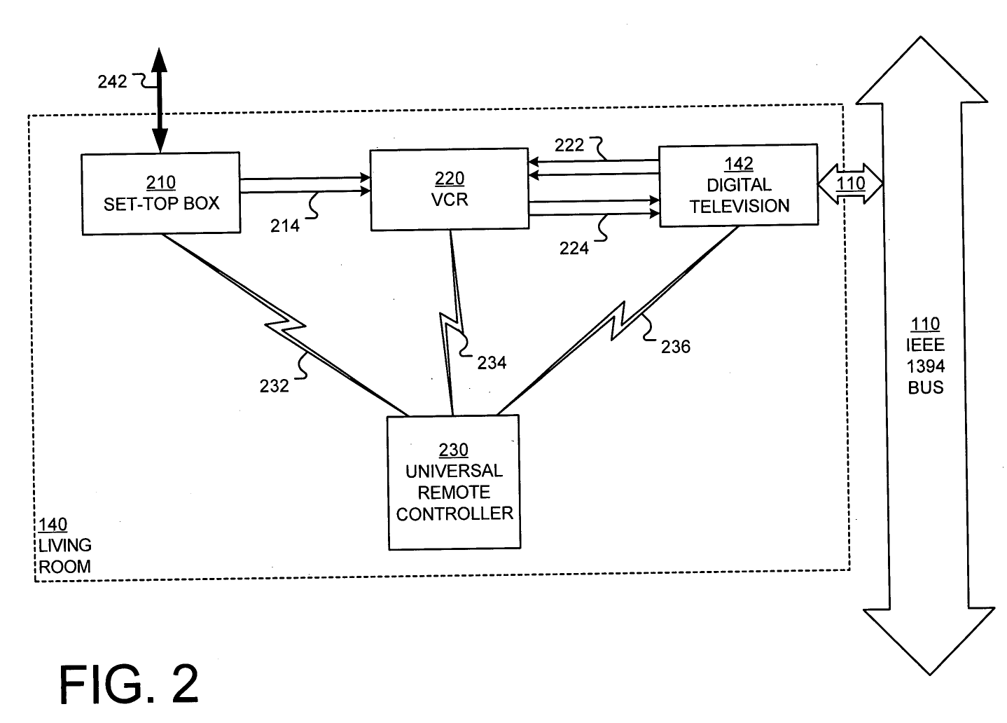

FIG. 2 is a block diagram showing infrared (IR) controllable analog devices connected to a network-compliant device on the digital network of FIG. 1. Specifically, FIG. 2 shows an embodiment in which the DTV 142 of the living room 140 is connected to analog devices, such as, for example, a set-top box (STB) 220 and an analog video cassette recorder (VCR) 210, which are both controllable by a universal remote controller 230. The STB 210 is connected to the cable network, for example, through a coaxial cable 242.

As is known, the audio and video outputs of the DTV 142 can be electrically connected to the audio and video inputs of the VCR 220 using a standard audio/video cable 222, such as a coaxial cable or an audio and composite video cable (e.g., a cable bundle with red, white and yellow RCA jacks), among others. Similarly, the audio and video outputs of the VCR 220 can be connected to the audio and video inputs of the DTV 142 through a similar connection 224. Since analog VCRs typically permit daisy-chaining with other audio-visual equipment, such as, for example, a set-top box 210, the set-top box 210 can be daisy-chain connected to the DTV through similar audio and video connections 214. For some systems, the DTV 142 can also be connected to a digital network, such as, for example, an IEEE-1394 network through bus 110.

Since all three devices 210, 220, 142 are located within a single room, namely, the living room 140, a single universal remote controller 230 can be programmed to provide some degree of operation for all three devices 210, 220, 142, as long as those devices are within the line-of-sight for the remote controller 230. Alternatively, certain DTV models have a resident IR code library, such as the IR code library from Universal Electronics, Inc. (UEI), and attached IR transmitter. For those DTV models, a non-learning remote controller (not shown) can be used to control the DTV 142, which, in turn, can provide an infrared (IR) signal to the STB 210 and the VCR 220 using the IR transmitter that is resident on the DTV 142. This type of IR transmitter mechanism is also known as an IR blaster, which is known in the art. Since IR blasters and their functionality are well known to those having skill in the art, further discussion of IR blasters is omitted here.

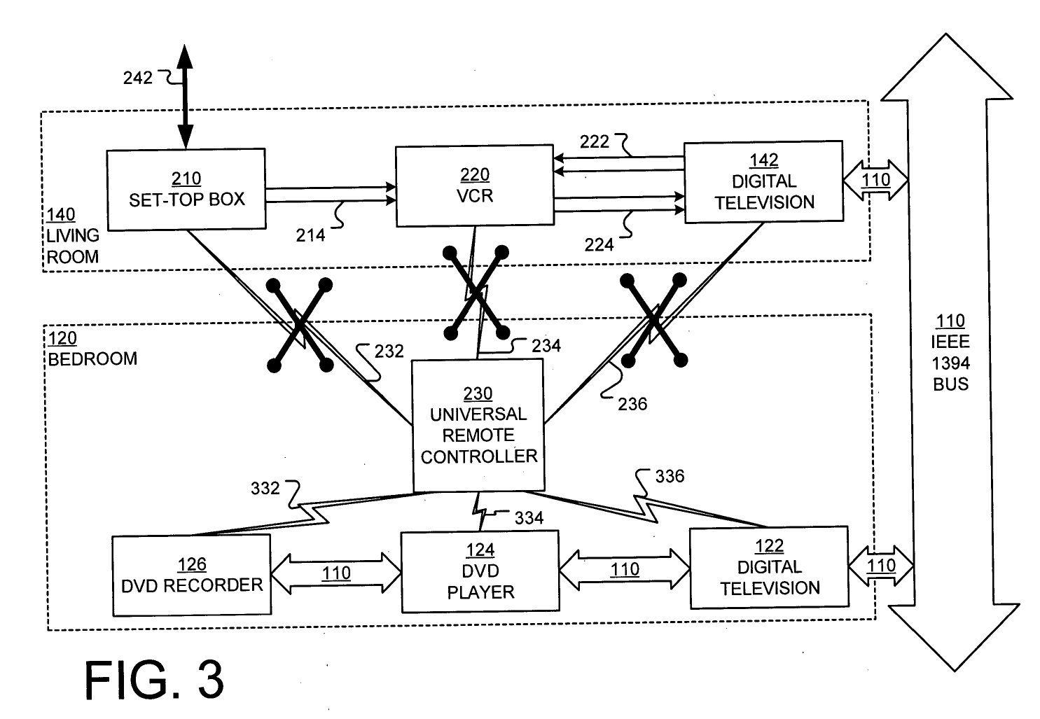

In any event, for those types of DTVs that have resident UEI IR code libraries, the analog devices that are connected to the DTV 142, such as the VCR 220 and the STB 210, can be indirectly controlled by the non-learning remote controller (not shown) through the DTV 142. Unfortunately, in the absence of a line-of-sight with a universal remote controller or IR blasters, these analog devices are typically not remotely controllable. An example of the line-of-sight limitation is shown in FIG. 3.

FIG. 3 is a block diagram showing examples of IR-controllable devices that are within range and beyond range of an IR remote control device. More particularly, FIG. 3 shows devices that are located in two separate rooms, namely, the living room 140 and the bedroom 120. As shown in FIG. 3, the living room 140 has a DTV 142 connected to the digital network via an IEEE-1394 bus. An analog VCR 220 and an STB 210 are daisy-chained to the DTV 142. The bedroom 120 also has a DTV 122 that is connected to the digital network via the IEEE-1394 bus. A DVD recorder 126 and a DVD player 124 are daisy-chain connected to the DTV 122 using IEEE-1394 buses.

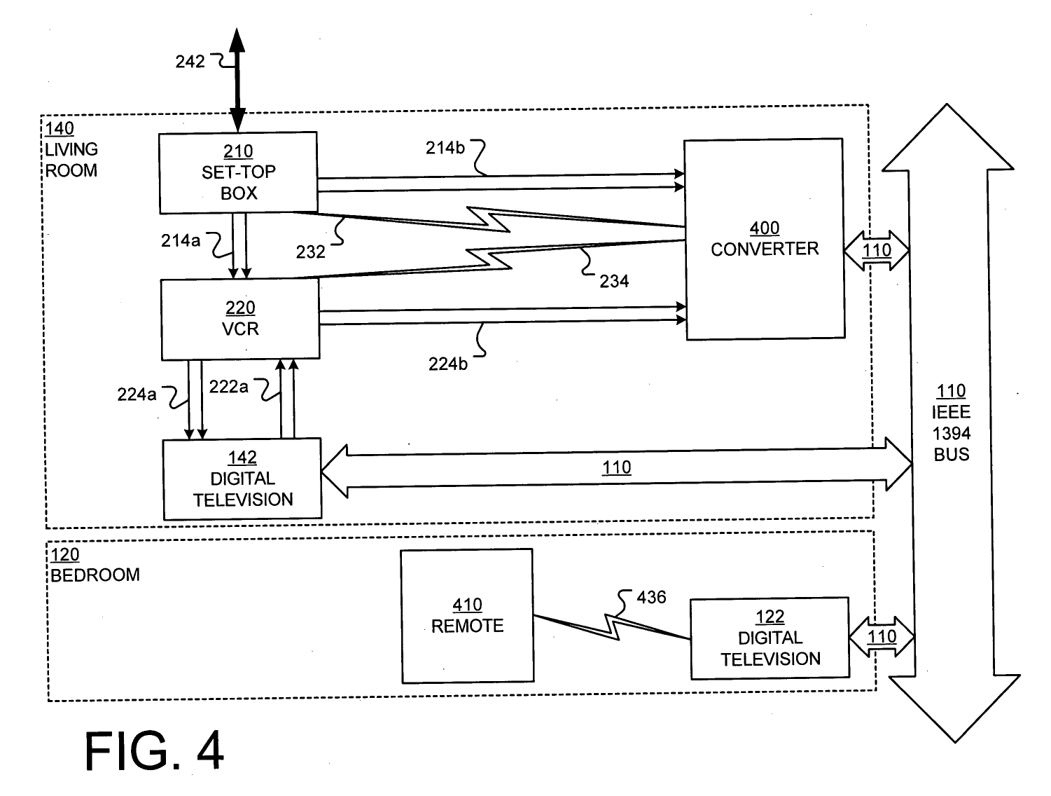

As seen in FIG. 3, the universal remote controller 230 is in the bedroom 120, and is therefore within the line-of-sight of the DVD recorder 126, the DVD player 124, and the DTV 122, which are all located in the bedroom 120. However, the universal remote controller 230 is not within the line-of-sight to the analog VCR 220, the STB 210, and the DTV 142, which are located in the living room 140. Thus, while the universal remote controller 230 can control the functions of the DVD recorder 126, the DVD player 124, and the DTV 122, it cannot control the functions of the devices in the bedroom. IR non-learning remote controllers (not shown), similar to the universal remote controller 230 described above, generally suffer from the same limitation, insofar as those remote controllers typically control only those devices that are within the line-of-sight of the remote controller's IR transmitter. Several embodiments of systems, such as those shown in FIGS. 4 through 8, remedy this problem by providing devices and systems that are configured to interface various devices to a digital network.

Specifically, FIG. 4 shows an embodiment of a system, in which a converter 400 provides a digital network with access to IR-controllable devices. As shown in FIG. 4, a DTV 122 is located in a bedroom 120 and connected to a digital network, such as, for example, an IEEE-1394-compliant network through bus 110. Along with the DTV 122, a remote controller 410 is located in the bedroom 120 within the line-of-sight of the DTV 122. The remote controller 410 can be a universal remote controller, which is programmable by a user, or a non-learning remote controller, which is not readily programmable by a user. Being in the same room as the DTV 122, the remote controller 410 can directly access the DTV 122 through an IR communication channel 436 (or by directly broadcasting IR signals to line-of-sight devices).

In a living room 140, which is beyond the line-of-sight of the remote controller 410, there resides a converter 400, which is also connected to the digital network (e.g., the IEEE-1394-compliant bus 110). An analog VCR 220, a STB 210, and a DTV 142 are also located in the living room 140. The DTV 142 in the living room is also connected to the digital network (e.g., through the IEEE-1394-compliant bus 110), while both the analog VCR 220 and the STB 210 are daisy-chained to the DTV 142 over standard audio-visual (AV) cables 214, 222, 224, such as, for example, composite RCA adapter, S-Video, or other known AV cables. In some embodiments, DTV 142 is not present.

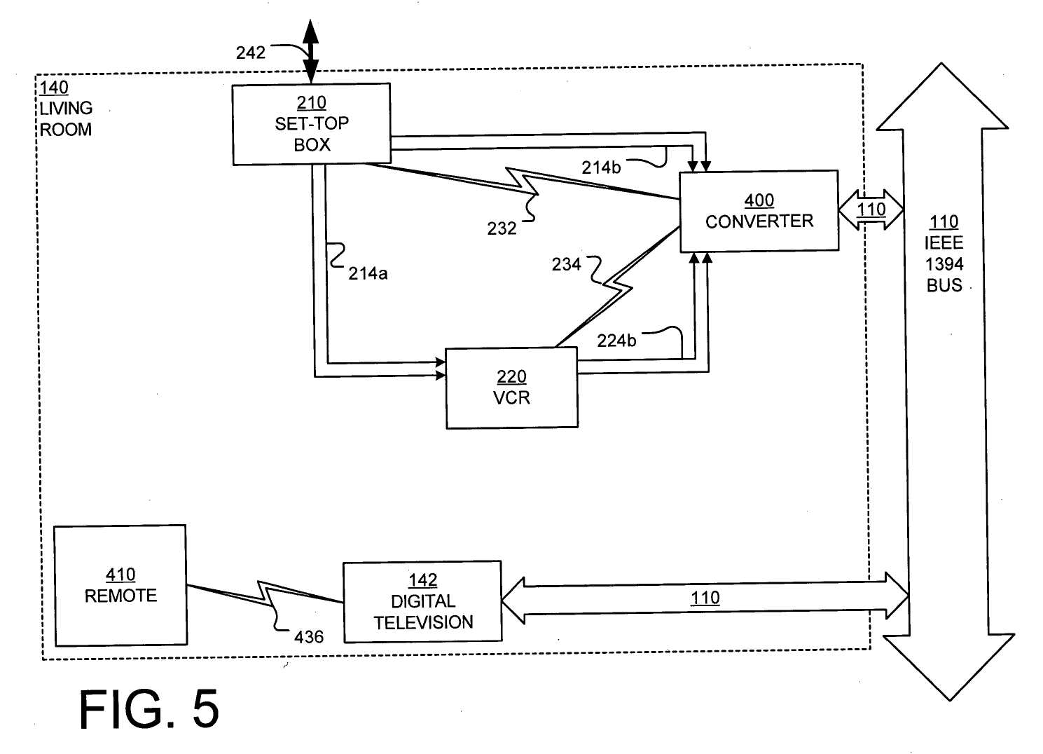

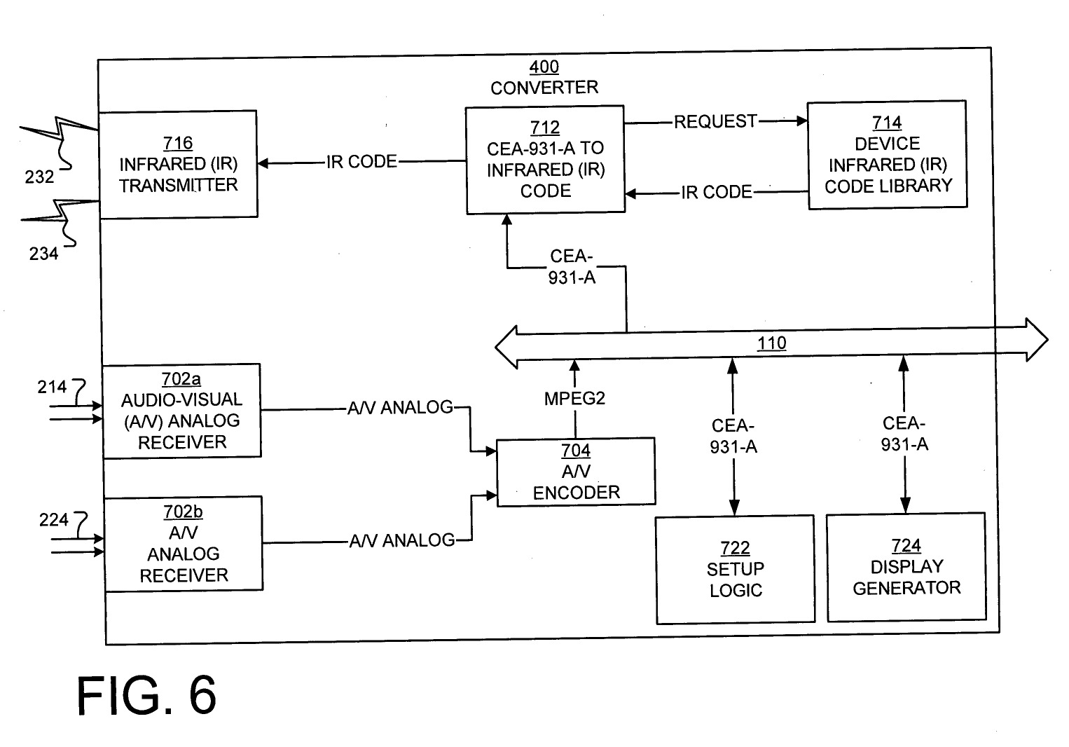

Being beyond the line-of-sight of the remote controller 410, which is located in another room, neither the VCR 220 nor the STB 210 are directly controllable by the remote controller 410. However, the converter is configured to provide remote access to both the analog VCR 220 and the STB 210 over the digital network. In that regard, the converter 400 is configured to provide IR commands to the STB 210 over an IR channel 232. Similarly, the converter 400 is configured to provide IR commands to the VCR 220 over another IR channel 234. The various components responsible for the functioning of the converter 400 are described below, with reference to FIGS. 6 through 8. Furthermore, the setup and selection process for the various devices is provided with reference to FIGS. 6 through 8. Hence, only a truncated discussion of those functions is provided with reference to FIGS. 4 and 5.

It should be appreciated that these IR channels 232, 234 can be defined by separate IR transmitters, or defined by a single IR transmitter that has logically distinguishable IR signals. While IR channels are described, it should be appreciated that the IR signals may be broadcast by the controller 400, and recognized or ignored by the various devices within the room, depending on whether the IR signals are recognizable by those devices.

Continuing the description of FIG. 4, one embodiment of a forward and backward path is provided. Using a specific example of an IEEE-1394-compliant network, the converter 400 is configured to connect to the network and announce its presence on the network, as described below. In that regard, the converter 400 is recognized by the network in accordance with IEEE-1394 standards. Being IEEE-1394 compliant, all other devices on the IEEE-1394 network are capable of communicating with the converter 400 over the IEEE-1394 bus 110.

Given this recognition by the IEEE-1394 network, the system of FIG. 4 operates in the following manner. When a user wishes to access the VCR 220 in the living room 140, the user can select one of the VCR functions (e.g., play, record, eject, rewind, etc.) on the remote controller 410. Since the remote controller 410 is within the line-of-sight of the DTV 122 in the bedroom 120, that selection is conveyed from the remote controller 410 to the DTV 122 over an IR channel (or path) 436. The DTV 122, being connected to the IEEE-1394 network, conveys that command to the converter 400 over the IEEE-1394 bus 110 using CEA-931-A operational command signals.

The converter 400 receives the CEA-931-A signals and converts those CEA-931-A signals into an IR-command signal for the VCR 220 using the components described with reference to FIGS. 6, 7, and 8. Since the VCR 220 and the converter 400 are in the same room, namely, the living room 140 in FIG. 4, the converter 400 can transmit the IR-command signal to the VCR 220 over an IR path 234, or by broadcasting the IR signal, which is then detected by the VCR 220. The VCR 220, upon receiving the IR-command signal, executes the command.

Thus, for example, if a “rewind” command is sent from the remote controller 410 in the bedroom 120, then the VCR 220 in the living room 140 will rewind the tape that is in the VCR 220. Similarly, if a “play” command is sent from the remote controller 410 in the bedroom 120, then the VCR 220 in the living room 140 will play the tape that is in the VCR 220. As one can see, the IR-controllable devices can be remotely controlled in the absence of a line-of-sight to those devices from the remote controller 410.

FIG. 4 also shows an embodiment of a system, in which a converter 400 provides IR-controllable devices access to a digital network. While an IEEE-1394-compliant network is used for illustrative purposes, it should be appreciated that other digital networks can be similarly configured to provide similar connections.

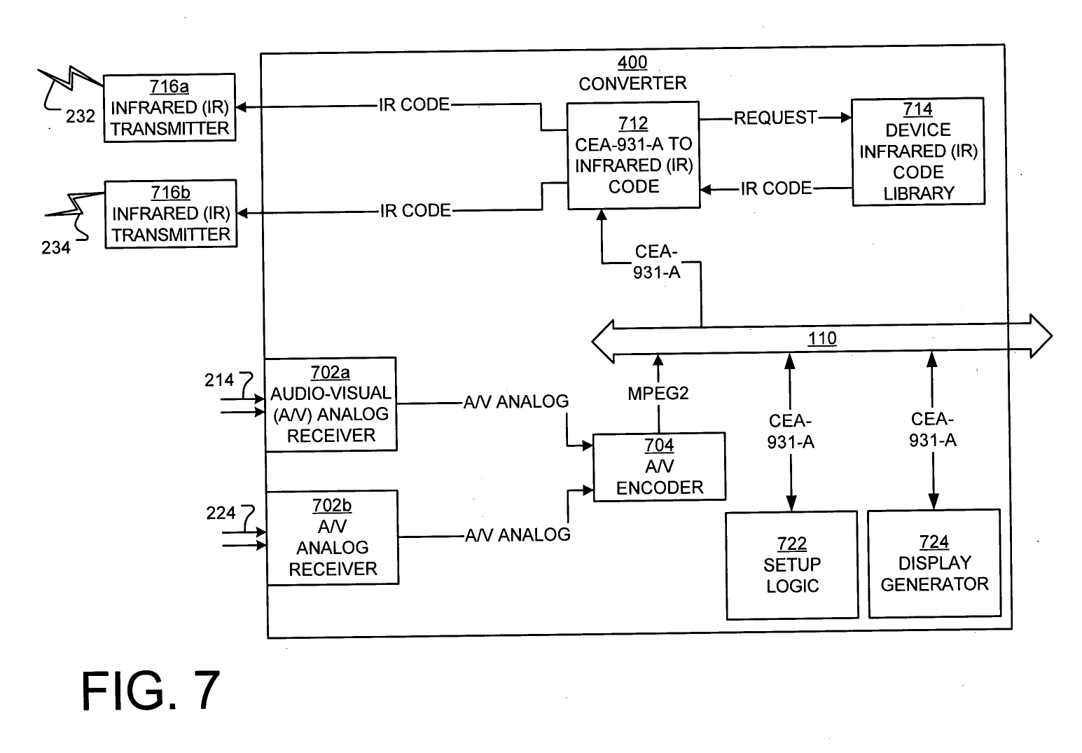

As shown in FIG. 4, the VCR 220 and the STB 210 provide their analog output to the converter 400 through respective AV cables 214, 224. Thus, for example, when a user in the bedroom 120 selects a pay-per-view movie option using the remote controller 410 in the bedroom 120, that selection is conveyed to the STB 210 in accordance with the description of FIG. 4. Once the STB 210 receives the selection and begins playing the pay-per-view movie, the AV analog signals are conveyed to the converter 400 through the AV cable 224 of the STB 210. The converter 400 receives the AV signals, which carry the pay-per-view movie, and converts the AV signals into digital format in accordance with the teachings of FIGS. 6 and 7. The AV signal which is converted to the digital domain and carried onto the 1394 network corresponds to the analog device selected by the user. It should be appreciated, however, that 1394 allows multiple digital streams to be carried, and therefore the converter is not limited to carrying one AV stream at a time.

For the embodiment of FIG. 4, the digital format is-an MPEG2 Single- Program Transport Stream (SPTS), which can be transported over the IEEE-1394 bus 110. The converter 400 places one or more MPEG2 SPTS signals onto the IEEE-1394 bus 110. The MPEG2 SPTS signal(s) are received by the DTV 122 in the bedroom 120. The DTV 122, which is capable of playing MPEG2, decodes the MPEG2 SPTS and plays the pay-per-view movie to the user in the bedroom 120. Thus, as shown in FIG. 4, a user can access the STB 210 in the living room 140 without a physical line-of-sight to the STB 210.

While the converter of FIG. 4 shows only an STB 210 and a VCR 220 connected to the converter 400, it should be appreciated that the converter 400 can include a bank of jacks, such as, for example, standard RCA adapter jacks, S-video jacks, etc. in order to provide compatibility with multiple devices. In one embodiment, standard RCA jacks for audio and composite video (e.g., red, white & yellow) are provided for AV inputs. The number of jacks can be varied to accommodate any number of devices. The setup process, as described below, provides a user with the capability to indicate which of the jacks are being used to connect to which devices, and which are not being used. Alternatively, for another embodiment, among others, the converter 400 can be set up with a “plug-and-play” type of mechanism, thereby automatically detecting whether or not a device is connected to a particular jack. For that embodiment, once a device is detected, the converter 400 can prompt a user for input as to the type of device, the make, and the model, in accordance with the description provided below (see FIGS. 6 through 8).

FIG. 5 shows yet another embodiment of a system, in which a converter 400 provides IR-controllable devices with access to a digital network. In the embodiment of FIG. 5, the converter further provides the digital network with access to the IR-controllable devices. Unlike the embodiments of FIG. 4, the embodiment of FIG. 5 shows both the IR-controllable devices and the converter 400 being co-located in the same room, namely, the living room 140.

Using the configuration of FIG. 5, a user provides a “rewind” IR command for the VCR 220 through the remote controller 410 to the DTV 142. The DTV 142 conveys the “rewind” command to the converter 400 over the IEEE-1394 bus 110, in a manner similar to that described with reference to FIG. 4. The converter 400 receives the “rewind” command over the IEEE-1394 bus 110, and converts that command into an IR “rewind” command signal for that VCR 220. The IR “rewind” command signal is conveyed to the VCR 220 over an IR path 232. When the VCR 220 receives the “rewind” command, the tape in the VCR 220 begins to rewind as if the user had directly used the remote controller for the VCR 220.

Substantially synchronously, the converter 400 conveys a corresponding “rewind” display back to the DTV 142 so that the DTV 142 can display, to the user, that the tape in the VCR 220 is being rewound.

For devices that have a built-in user interface, the DTV 122 simply displays the regular signal from those devices. For other devices, such as a CD player, which typically does not have on-screen user interfaces, the converter 400 generates and displays a user interface for those devices, in some embodiments. Thus, for example, if a native remote controller for a CD player has a “disc selection” button, the converter 400 would generate a UI that includes an equivalent command. Arrow keys or other buttons that can be used for navigation on remote 410 are used in some embodiments to interact with such on-screen user interfaces. In other words, for remote controllers that are associated with non-UI devices, the converter 400 would generate an equivalent software control code for IR command signal output based on generated user interface interaction that would substitute for the hardware button on a native remote controller. Similarly, all or a portion of functions of native remote controllers for devices with and without on-screen interfaces can be provided by converter 400.

As shown in FIGS. 4 and 5, by providing a converter 400 that interfaces IR-controllable devices to a digital network, the IR-controllable devices can be controlled from remote locations by a remote controller 410, which is not within the line-of-sight of the IR-controllable devices. In that regard, a user has greater flexibility and versatility in arranging and placing IR-controllable devices in various rooms. Furthermore, since a single IR-controllable device can be operated from any room that is connected to the digital network, a user need not purchase multiple duplicative devices for each room or run as many cables.

While various embodiments are shown with devices being located in different rooms, it should be appreciated that, for aesthetic or functional reasons, the IR-controllable devices can also be placed in a closet or shelf in the same room, which is beyond the line-of-sight of the remote controller 410. In that regard, the bedroom 120 and the living room 140 are simply provided as examples of places in which a remote controller 410 does not have a direct line-of-sight to corresponding IR-controllable devices. Likewise, it should be appreciated that the embodiments of FIGS. 4 and 5 will function just as well, even if a line-of-sight does exist between the IR-controllable devices and the remote controller 410.

FIG. 6 is a block diagram showing an embodiment, among others, of the components of the converter 400, which are configured to convert Consumer Electronics Association (CEA) 931-A commands, Home Audio Video Interoperability (HAVi) commands, or other similar commands, into an IR command signal. Other embodiments include any other output format understood by devices as being control signals. As is known by those having skill in the art, CEA-931-A, HAVi, and other similar protocols provide the operational commands that can be carried on an IEEE-1394-compliant bus. In that regard, it should be appreciated that CEA-931-A and HAVi are merely two examples, among others, of digital signals that are carried on an IEEE-1394-compliant bus, and, more generally, two examples, among others, of digital signals that are carried on digital networks. Since CEA-931-A, HAVi, and IEEE-1394, and other standards for digital communications are known in the art, further discussions of those standards are omitted here.

As shown in FIG. 6, the converter 400 includes an IR transmitter 716, conversion logic 712, and an IR code library 714. Specifically, FIG. 6 shows the IR code library 714 to have, for example, UEI device IR codes. The conversion logic 712 is coupled to the IEEE-1394 bus 110. FIG. 6 also shows the conversion logic 712 as being a particular CEA-931-A-to-UEI-IR-code conversion logic. The converter 400 of FIG. 6 further comprises setup logic 722 and display generator logic 724, which are both connected to the IEEE-1394 bus 110. In addition to these components, the converter 400 further comprises an audio-visual (AV) encoder, which is also communicatively coupled to the IEEE-1394 bus 110. The AV encoder 704 is further coupled to the AV receivers 702a, 702b (collectively referred to herein as 702). While only two receivers 702 are shown in FIG. 6, a preferred embodiment will have a bank of four receivers, each of which can be coupled to a different device. It should appreciated that the number of AV receivers 702 can be varied to accommodate any number of devices for connection to the converter 400.

The setup logic 722 permits a user to setup the converter 400 to be compatible with various analog devices and other IR-controllable devices. In that regard, the setup logic 722 is a programmable component through which a user can store information related to those devices. For example, if a user has an analog VCR 220, the user can setup the converter 400 to communicate with the analog VCR 220. Thus, the user can provide specific make and model information to the converter 400 through the setup logic 722.

For some embodiments, among others, the setup logic 722 may be accessed through a DTV 122 from a different room in accordance with EIA-775A, which is a well-known standard in the art. For those embodiments, when the DTV 122 recognizes the converter 400 as being on the network, the converter 400 can be selected from the DTV 122 as an available device for control through the DTV 122. Once the converter 400 has been selected through the DTV 122, a user interface (UI) is transmitted from the converter 400 to the DTV 122 for display on the DTV 122. That UI permits the user to provide information on the various devices that are connected to the converter 400. Thus, for example, if a Samsung® VCR is connected to the converter 400, then the following process can take place for setup. First, the UI can display a variety of devices (e.g., VCR, STB, DVD, CD, etc.) on the DTV 122. The user selects “VCR” from the provided options. Upon selecting the “VCR” option, the UI further displays a variety of makes (e.g., Samsung®, Hitachi®, Sony®, etc.). The user then selects “Samsung®” as the make. Thereafter, a variety of models for Samsung® VCR's can be displayed to the user, at which point, the user can select the appropriate model through the UI on the DTV 122.

In another embodiment, among others, the setup logic 722 can be accessed through a front-panel (not shown) on the converter 400. That front panel may include, for example, a liquid crystal display (LCD) screen, which provides similar menu options as that of the DTV 122 UI embodiment, above. For the front-panel LCD embodiment, the user would follow similar steps to configure the converter 400 for the various devices that are connected to the converter 400. Other embodiments include no displaying of setup information. In addition, some embodiments include a remote controller associated with the converter 400, which could also be used during setup.

The setup logic 722, for some embodiments, is configured to register the converter 400 with the IEEE-1394 network. In one embodiment, among others, the setup logic 722 registers only the converter 400 with the IEEE-1394 network, in accordance with the IEEE-1394 standard. For that embodiment, the other devices on the IEEE-1394 network recognize only the converter 400 on the network, without any knowledge of devices that may be connected to the AV receivers 702 on the converter 400.

For that embodiment, when a user accesses multimedia devices on the IEEE-1394 network through a DTV, the DTV displays the converter 400 as an available device. The user can select the converter 400 from the DTV display, at which point on-screen representations of the various devices connected to the converter 400 are, in one example, displayed to the user on the DTV. Thus, for example, if an analog VCR and a STB are connected to the converter 400, then the DTV will display an option for the analog VCR and an option for the STB when the user selects the converter 400 through the DTV.

In another embodiment, among others, the setup logic 722 does not register itself on the IEEE-1394 network but, rather, registers the devices that are connected to the converter 400. For example, if an analog VCR and a STB are connected to the converter 400, then the setup logic 722 registers the analog VCR and the STB with the IEEE-1394 network, in accordance with the IEEE-1394 standard. For that embodiment, the other devices on the IEEE-1394 network recognize the analog VCR and the STB as being on the network, without knowledge of the converter's presence on the network. In other words, the converter 400 acts as a proxy for the analog VCR and the STB.

For that embodiment, when a user accesses multimedia devices on the IEEE-1394 network through a DTV, the DTV displays the analog VCR and the STB as being available devices. The DTV does not display the converter 400 as an available device. Thus, a user at the DTV can select either the analog VCR or the STB without knowledge of the converter's existence. In other words, the converter 400 is transparent to the DTV.

In yet another embodiment, the setup logic 722 registers both the converter 400 and all of the devices connected to the converter 400. For that embodiment, the other devices on the IEEE-1394 network recognize the converter 400 as being on the network, and also recognize, for example, the analog VCR and the STB as being on the network, should those devices be connected to the converter 400.

In some embodiments, among others, the setup logic 722 is configured to provide a user interface (not shown) for display on DTV 122, through which a user can input the make and model of the user's analog VCR 220. Likewise, should the user desire the converter 400 to communicate with STB 210, then the user can provide make and model information for the STB 210 to the converter 400 through the user interface (not shown) that is supplied by the setup logic 722. Depending on the implemented embodiment, the user interface, which is displayed at the DTV 122, provides the user with an interface for the converter 400, or the analog VCR 220 and the STB 210, or all of these devices.

Once the user provides information on all of the devices with which the converter 400 will communicate, the setup logic 722 stores that information for later use. Similarly, information on CD players (or CD changers), DVD players, or other devices can be provided to the converter 400 for later use. These devices can be configured similar to how the analog VCR 220 and the STB 210 were configured, above.

In another embodiment, the converter 400 itself may have a graphical user interface (not shown) for inputting the setup commands for various makes and models of devices. Alternatively, the converter 400 may have a front-panel control that permits a user to enter the various makes and models of the devices that are connected to the converter 400.

Regardless of how the information is provided to the converter 400, once that information has been provided, the setup logic 722 stores that information for later use.

In order to provide a user interface (UI) for accessing the setup logic 722, the converter 400 transmits the various preprogrammed UIs to the DTV 122 using, in one embodiment, the EIA-775A standard, which is know to those having skill in the art.

When the converter 400 is the selected device on the DTV 122, the DTV 122 passes the remote control commands as CEA-931-A commands to the converter 400. The process of passing CEA-931-A commands from a DTV 122 is well known to manufacturers of DTVs and DTV remote controls and is, therefore, not discussed further herein.

The converter 400 presents, on its UI, a list of analog devices that the user has connected and configured per the setup logic 722. The user selects an individual analog device to control, and the converter 400 presents a UI which is appropriate for that device. Alternatively, the converter 400 may recognize that there are no conflicting commands between the various connected devices (e.g., only one device has a “rewind” command), and the user may therefore begin entering remote commands immediately, without first selecting the device to control.

In the embodiment where the converter 400 is transparent to the DTV 122, the UI on the DTV 122 appears, for all intents and purposes, as the UI for the selected device. Thus, if both the analog VCR 220 and the STB 210 have been recognized by the IEEE-1394 network, then the DTV shows a UI for the analog VCR 220 if the analog VCR 220 is selected, and the DTV 122 shows the UI for the STB 210 if the STB 210 is selected.

In the embodiment where the converter 400 is the only device that is registered with the IEEE-1394 network, the UI on the DTV 122 shows only the converter 400 as a selectable option. Once the converter 400 is selected, another UI is displayed on the DTV 122. That other UI shows all of the devices (e.g., analog VCR 220, STB 210, etc.) that are connected to the converter 400. In that regard, rather than being transparent, the converter 400 mediates all transactions between the DTV 122 and the devices connected to the converter 400. Once the various options for devices are presented to the user on the DTV 122, the user can follow the steps outlined above, the difference being that the converter-mediated process is no longer transparent to the user. Rather, the user is aware that the transaction is being directed through the converter 400.

The IR code library 714 has make, model, and command information for known IR-controllable devices. For example, if the IR code library 714 is a UEI device IR code library, which is well known in the art, then the IR code library 714 has information related to all known makes and models of VCRs, DVDs, etc. that are IR-controllable. More specifically, the UEI device IR code library has, for example, the IR cod that corresponds to a “rewind” command for a Sony® VCR; the IR code that corresponds to an “eject” command for a Samsung® CD changer; the IR code that corresponds to a “play” command for a Mitsubishi® DVD player, etc. In that regard, the IR code library is a repository of IR code information for various IR-controllable devices.

The conversion logic 712 is configured to receive a digital signal from the digital network, and convert the digital signal into an IR command signal. Specifically, as shown in FIG. 6, the CEA-931-A-to-UEI-IR-code conversion logic 712 is configured to receive a CEA-931-A signal from the IEEE-1394 bus. For some embodiments, the CEA-931-A signal represents a command associated with a device for which the converter 400 has been set up.

For example, if the converter 400 has been set up for an analog VCR 220, then the CEA-931-A signal can represent, among others, a standard command for the VCR 220, such as, for example, turn on, turn off, play, rewind, fast-forward, record, pause, stop, eject, or even a channel selection in the event that the VCR functions as a tuner.

Similarly, if the converter 400 has been setup for a CD player (not shown), then the CEA-931-A signal can, among others, represent a standard CD player command, such as, for example, turn on, turn off, play, skip forward, skip backward, pause, change disc, stop, eject, etc. Likewise, if the converter 400 has been setup for an STB 210, then the CEA-931-A signal can, among others, represent a standard STB command signal, such as, for example, turn on, turn off, channel select, option select, etc. Also, if the converter 400 has been setup for a digital video recorder (DVR, not shown), the CEA-931-A signal can, among others, represent a standard DVR command signal, such as, for example, turn on, turn off, play, back, forward, record, pause, channel select (should the DVR also be configured as a tuner), option select, stop, select, eject, etc. As is known, these commands can be displayed on the screen of the DTV 122.

As one can see, the CEA-931-A signal can represent any number of commands for any number of devices for which the converter 400 has been setup. Additionally, it should be appreciated that the CEA-931-A signal can represent non-standard or customizable signals, so long as the converter 400 is configured for such a setup.

Upon receiving the CEA-931-A signal, the conversion logic 712 determines the appropriate device that corresponds to the received CEA-931-A signal.

This determination can be made by one of various methods. If the CEA-931-A signal only has meaning for one of the connected analog devices, the conversion logic 712 will immediately look up the IR code for that device. However, if the CEA-931-A signal has meaning for more than one connected device, the signal will be applied to the analog device last selected by the user. In other embodiments, the signals are addressed in a manner associated with particular devices.

Once the appropriate device and the corresponding command is determined from the CEA-931-A signal, the conversion logic 712 accesses the IR code library 714 for an IR code that corresponds to the CEA-931-A signal. For some embodiments, the IR code library 714 is accessed in a query-and-respond fashion, which is known by those having skill in the art. Thus, for those embodiments, the conversion logic 712 issues a request to the IR code library 714, and the IR code library 714 responds to the request by providing the appropriate IR code, which corresponds to the CEA-931-A signal.

The conversion logic 712 receives the IR code and generates an IR command signal that corresponds to the IR code. As is known, the IR command signal, for some embodiments, is a pulse string that is recognized by an IR-controllable device. That IR command signal is conveyed to the IR transmitter 716 for transmission to the IR- controllable device through IR channels 232, 234.

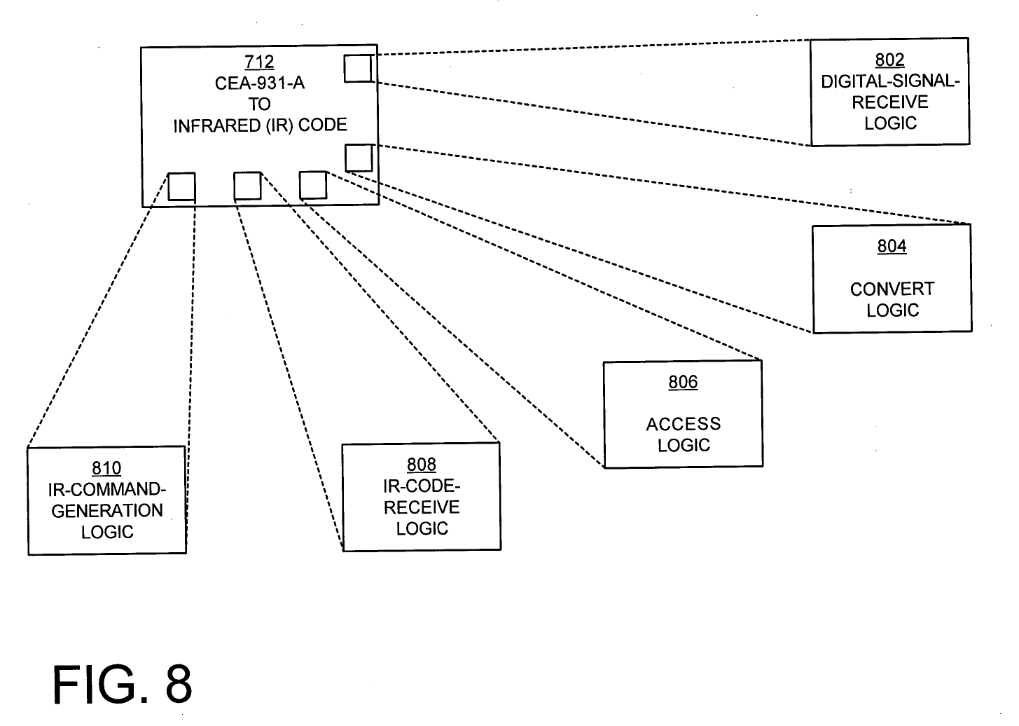

The functional components of the conversion logic 712 are shown in greater detail in FIG. 8, which shows one embodiment, among others, of logical components that convert digital signals into IR-command signals. As shown in FIG. 8, the conversion logic 712 comprises digital-signal-receive logic 802, convert logic 804, access logic 806, IR-code-receive logic 808, and IR-command-generation logic 810. The digital-signal-receive logic 802 is configured to receive the digital signal, such as, for example, the CEA-931-A signal from the IEEE-1394 bus. The convert logic 804 is configured to convert the digital signal into a query for the IR code library 714. In other embodiments, the convert logic 804 can simply generate a query based on the received CEA-931-A signal, rather than converting one signal into another. The access logic 806 is configured to access the IR code library 714 for the IR code that corresponds to the received digital signal. The IR-code-receive logic 808 is configured to receive the IR code from the IR code library 714, once the IR code library has been accessed. The IR-command-generation logic 810 is configured to generate the IR command signal from the IR code. The generated IR command signal, for some embodiments, is a pulse train that represents a command that is recognizable by the IR-controllable device.

Continuing the description of FIG. 6, the display generator 724 is configured to generate a display having a user interface. The user interface includes various command options that are associated with one or more IR-controllable devices. Thus, for example, if the converter 400 has been setup for an analog VCR 220, then the user interface provides the commands associated with the analog VCR 220, such as, for example, play, rewind, fast-forward, eject, etc. The display and the user interface are conveyed over the IEEE-1394 bus 110 using CEA-931-A-compliant operational commands. In that regard, the user interface can be displayed on any device that is connected to the IEEE-1394 bus 110, such as, for example, DTV 142, personal computer 132, or any device on the IEEE-1394 bus 110 that is capable of displaying a screen to a user. Preferably, the user provides commands for controlling the IR-controllable devices through this user interface. Alternatively, the commands can be provided through a front-panel (not shown), rather than through an IR remote controller.

The AV receivers 702 are configured to receive AV signals from various IR-controllable devices, such as, for example, the analog VCR 220 and the STB 210. In that regard, the AV receivers 702 are coupled to the AV cables 214, 224 from those IR-controllable devices. Thus, the AV receivers 702 is configured to receive the audio-visual signals from the IR-controllable devices through those devices' respective AV output cables 214, 224.

The AV encoder 704 is interposed between the AV receivers 702 and the digital network. As shown in FIG. 6, the AV encoder 704 provides the interface between the AV receivers 702 and the IEEE-1394 bus 110. The AV encoder 704 is configured to receive the AV analog signals from the AV receivers and convert the AV analog signals into digital format. In one embodiment, among others, the AV analog signals are converted to a motion pictures expert group (MPEG) format such as, for example, MPEG2, MP3, or other known digital format. Since MPEG standards, as well as other digital formats, are known in the art, further discussion of those standards is omitted here, and those standards are incorporated herein by reference, as if set forth in their entireties.

As shown in FIGS. 6 and 8, the conversion logic 712, the IR code library 714, and the IR transmitter 716 provides a forward path from the digital network to the IR-controllable devices. Conversely, the AV receivers 702 and the AV encoder 704 provides a backward path from the IR-controllable devices to the digital network. Various embodiments of forward and backward paths are provided in FIGS. 4 through 6.

FIG. 7 shows another embodiment of the converter 400. While the embodiment of FIG. 7 is similar to the embodiment of FIG. 6, it is distinct insofar as multiple IR transmitters 716a, 716b are responsible for transmitting the IR signal to their respective devices, and those IR transmitters 716a, 716b are wired external to the converter. Thus, for example, the first IR transmitter 716a transmits the IR signal to the analog VCR 220, while the second IR transmitter 716b transmits the IR signal to the STB 210. In that regard, it should be appreciated that the number of IR transmitters 716 can be varied to accommodate any number of IR-compatible devices that are connected to the converter 400.

For those embodiments in which multiple IR transmitters 716 are employed, the conversion logic 712 is further configured to determine the appropriate IR transmitter 716 to output the IR signal. In that regard, should the IR code from the device IR code library 714 be indicative of an analog VCR command, then the conversion logic 712 would select the first IR transmitter 716a as the appropriate transmitter. Similarly, should the IR code be indicative of a STB command, then the conversion logic 712 would select the second IR transmitter 716b as the appropriate transmitter.

In some embodiments, the number of IR transmitters 716 would correspond to the number of AV receiver jacks 702. Also, while only one IEEE-1394 bus is shown in FIGS. 6 and 7, it should be appreciated that multiple IEEE-1394 input/output ports can be provided to, for example, daisy-chain the converter 400 with other devices on the IEEE-1394-compliant network.

Since the other components of FIG. 7 correspond to those components described in FIG. 6, further description of those components is omitted here.

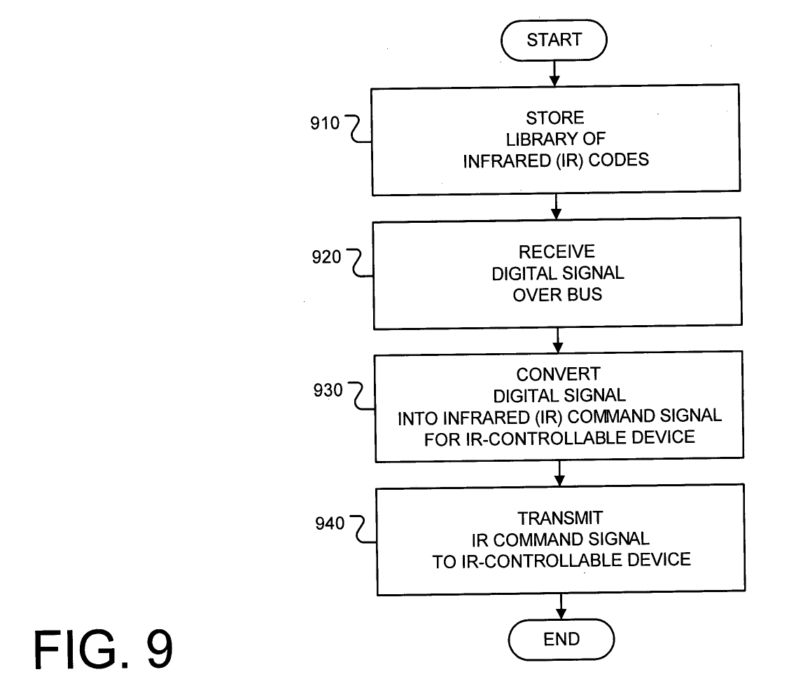

Having described various embodiments of systems and devices for connecting IR-controllable devices to digital networks, attention is turned to FIG. 9, which shows an embodiment of a method for connecting IR-controllable devices to digital networks.

FIG. 9 is a flowchart showing an embodiment, among others, of a process for connecting IR-controllable devices to a digital network. As shown in FIG. 9, one embodiment, among others, of a process for connecting IR-controllable devices to a digital network includes the step of storing (910) a library of IR codes. These IR codes may be pre-programmed into the converter 400, and/or downloaded to the converter, for example, through an Ethernet port. In some embodiments, the library of IR codes can include, for example, UEI IR codes, which are known in the art and used by conventional IR blasters. For other embodiments, the library of IR codes can be proprietary IR codes that are specifically configured for particular models.

As part of the setup process, the user configures which device is connected to which set of analog inputs and outputs. The converter 400 therefore knows how-to direct signals from its internal analog-to-digital encoders to the digital network, similar to the description provided with reference to FIGS. 6 through 8.

Once the IR code library has been stored, the process can provide an interface between IR-controllable devices and a digital network. As such, the process of FIG. 9 also includes the step of receiving (920) a digital signal over a bus, and converting (930) the digital signal into an IR command signal for an IR-controllable device. In some embodiments, the digital signal can be an IEEE-1394-compliant signal, which originates from an IEEE-1394 bus. In other embodiments, the digital signal can originate from a USB, a SCSI, ethernet, or a variety of other digital buses. Upon conversion, the IR command signal is transmitted (940) to the IR-controllable device. The IR-controllable device can be, for example, an analog VCR, a set-top box, a CD changer or CD player, a DVD player, a home entertainment system, or any other IR-controllable device (or other wirelessly-controllable devices).

As shown in the process of FIG. 9, by providing a conversion process in which digital signals are converted to an IR command signal, those IR-controllable devices can now be controlled and operated by various devices that reside on the digital network. Thus, any digital device on the network can now communicate with those devices that were previously not amenable to such communication.

The IR-command-generation logic 810, the IR-code-receive logic 808, the access logic 806, the convert logic 804, the digital-signal-receive logic 802, the CEA-931-A-to-UEI-IR-code conversion logic 712, the setup logic 722, the display generator logic 724, the UEI device IR code library 714, and the AV encoder may be implemented in hardware, software, firmware, or a combination thereof. In the preferred embodiment(s), the IR-command-generation logic 810, the IR-code-receive logic 808, the access logic 806, the convert logic 804, the digital-signal-receive logic 802, the CEA-931-A-to-UEI-IR-code conversion logic 712, the setup logic 722, the display generator logic 724, the UEI device IR code library 714, and the AV encoder are implemented in hardware using any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In an alternative embodiment, the The IR-command-generation logic 810, the IR-code-receive logic 808, the access logic 806, the convert logic 804, the digital-signal-receive logic 802, the CEA-931-A-to-UEI-IR-code conversion logic 712, the setup logic 722, the display generator logic 724, the UEI device IR code library 714, and the AV encoder are implemented in software or firmware that is stored in a memory and that is executed by a suitable instruction execution system.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The converter 400 can also be embodied in a computer-readable medium as a computer program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations to the invention as described may be made. For example, while IEEE-1394, USB, SCSI, and variants thereof have been described, it should be appreciated that other digital backbones can be used as the basis of the digital network. Also, while analog set-top boxes and analog VCRs have been explicitly shown, it should be appreciated that the disclosed embodiments are also compatible with other analog devices. Moreover, while the embodiments are described with reference to analog devices, it should be appreciated that IR-controllable digital devices can also be connected to the digital network through the converter 400. Also, while various functions of the analog and digital devices are shown, it should be appreciated that the system can be configured to accommodate customized commands, future-developed commands, or other standard commands that are not explicitly enumerated above. Furthermore, while RGB cables and coaxial cables are shown in the embodiments above, it should be appreciated that analog devices can be connected to digital devices and to each other via other known connection mechanisms. Additionally, it should be appreciated that the disclosed systems and methods are not limited to home networks, but any digital network such as a local area network (LAN). All such changes, modifications, and alterations should therefore be seen as within the scope of the disclosure.

What is claimed is:

1. A conversion device comprising:
(A) a digital input port configured to receive an IEEE-1394-compliant signal;
(B) a converter configured to convert the IEEE-1394-compliant signal into an infrared (IR) command signal, the IR command signal being configured to command an IR-controllable device; and
(C) transmitting the IR command to the IR-controllable device, the IR controllable device being one selected from the group consisting of:
(1) an analog video cassette recorder (VCR);
(2) a compact disc (CD) player;
(3) a set top box; and
(4) a digital video recorder (DVR).

2. The system of claim 1, further comprising:
an encoder configured to receive an analog signal, the encoder further being configured to convert the analog signal into an IEEE-1394-compliant signal.

3. A system comprising:
a digital input port configured to receive a digital signal from a digital network;
a converter configured to convert the digital signal into an infrared (IR) command signal, the IR command signal being configured to command an IR-controllable device; and
an IR transmitter configured to transmit the IR command signal to the IR-controllable device.

4. The system of claim 3, further comprising:
an IR code library having an IR code, the IR code corresponding to an IR command signal for an IR-controllable device.

5. The system of claim 4, wherein the converter is further configured to access the IR code library, the IR code library being accessed for an IR code that corresponds to the received digital signal, the converter further being configured to receive the IR code from the IR code library, the converter further being configured to generate the IR command signal from the received IR code.

6. The system of claim 3, wherein the digital network is accessed by a bus, the bus being one selected from the group consisting of:
an ethernet bus;
a universal serial bus (USB);
a 10BaseT unshielded twisted pair (UTP) bus;
a small computer system interface (SCSI) bus;
a 100BaseT bus;
an IEEE-1394 bus; and
a variant thereof.

7. The system of claim 3, wherein the IR-controllable device is one selected from the group consisting of:
an analog video cassette recorder (VCR);
a compact disc (CD) player;
a set top box;
a digital video recorder (DVR); and
a variant thereof.

8. The system of claim 3, wherein the IR command signal provides a command, the command being one selected from the group consisting of:
a standard VCR command;
a standard CD player command;
a standard set top box command;
a standard DVR command; and
a variant thereof.

9. The system of claim 8, wherein the standard VCR command is one selected from the group consisting of:
turn on;
turn off;
play;
rewind;
fast-forward;
record;
pause;
channel X, wherein X represents a channel number;
stop; and
eject.

10. The system of claim 8, wherein the standard CD player command is one selected from the group consisting of:
turn on;
turn off;
play;
skip forward;
skip backward;
pause;
change disc;
stop; and
eject.

11. The system of claim 8, wherein the standard set top box command is one selected from the group consisting of:
turn on;
turn off;
channel X, wherein X represents a channel number; and
option Y, wherein Y represents an available option on the set top box.

12. The system of claim 8, wherein the standard DVR command is one selected from the group consisting of:
turn on;
turn off;
play;
back;
forward;
record;
pause;
channel X, wherein X represents a channel number;
option Y, wherein Y represents an available option on the DVR;
select;
stop; and
eject.

13. The system of claim 3, further comprising:
an audio-visual (AV) encoder configured to receive an AV analog signal, the AV encoder further being configured to convert the AV analog signal into a digital output signal, the AV encoder further being configured to place the digital output signal onto the bus.

14. The system of claim 13, wherein the digital output signal is in motion pictures expert group (MPEG) 2 format.

15. A method comprising the steps of:
receiving a digital signal from a digital network;
converting the digital signal into an infrared (IR) command signal for an IR-controllable device; and
transmitting the IR command signal to the IR-controllable device.

16. The method of claim 15, further comprising the steps of:
storing a library of IR codes, each IR code corresponding to a command, the command being native to the IR-controllable device.

17. An apparatus comprising:
digital-signal-receive logic configured to receive a digital signal; and
convert logic configured to convert the digital signal into an infrared (IR) command signal for an IR-controllable device.

18. The apparatus of claim 17, further comprising:
access logic configured to access an IR code library, the IR code library having an IR code that corresponds to the received digital signal;
IR-code-receive logic configured to receive the IR code from the IR code library; and
IR-command-generation logic configured to generate the IR command signal from the received IR code.

19. The apparatus of claim 17, further comprising:
means for accessing an IR code library, the IR code library having an IR code that corresponds to the received digital signal;
means for receiving the IR code from the IR code library; and
means for generating the IR command signal from the received IR code.

20. The apparatus of claim 17, further comprising:
setup logic configured to determine information related to the IR-controllable device, the information comprising a set of IR-command signals, the set of IR-command signals corresponding to the IR-controllable device.

21. The apparatus of claim 17, further comprising:
display generator logic configured to generate a display having a user interface, the user interface having command options, the command options being associated with the IR-controllable device.
